(19) United States
(12) Patent Application Publication
(10) Pub. No.: US 2002/0165751 A1
(43) Pub. Date: Nov. 7, 2002

(54) Reminder system using a service station

(76) Inventor: Bhargavi Upadhya, Bangalore (IN)

Correspondence Address: Michael E. Marion, Philips Electronics North America Corp., 580 White Plains Road, Tarrytown, NY, 10591, US

(21) Appl. No.: 10/122,743

(22) Filed: Apr. 15, 2002

(30) Foreign Application Priority Data
Apr. 17, 2001 (EP) 01201394.2

(51) Int. Cl. G06F 17/60

(52) U.S. Cl. 705/8

(57) ABSTRACT

A system is disclosed for reminding a person of an event. The system comprises at least one first device (1), e.g. a television or computer, with means for entering a reminder message. The system comprises at least one second device (3) associated with each first device (1) and a service station (4), with means for storing a reminder message and transmitting it to the second device (3) at a specified time, and a telecommunications network (6) through which a reminder message can be transferred from the first device (1) to the service station (4) and from there to the second device(s) (3) associated with the first device (1). The first device (1) comprises means for storing a reminder and automatically transferring it to the service station (4).

A device for use as a first device (1) in such a system is disclosed, and computer programs which can be loaded onto a programmable device to provide it with the functionality of the first (1) or second (3) device(s) or of the service station (4).

The invention relates to a system for reminding a person of an event, comprising at least one first device, e.g. a television or computer, with means for entering a reminder message, at least one second device associated with each first device, a service station, with means for storing a reminder message and transmitting it to the second device(s) at a specified time, and a telecommunications network through which a reminder message can be transferred from the first device to the service station and from the service station to the second device(s) associated with the first device. The invention further relates to a device to be used in such a system. The invention also relates to computer programs, which can be loaded onto a programmable device to provide it with the functionality of such a device and service station, respectively.

WO 99/14947 describes a system of the above-mentioned type that aims to remind an absent television viewer that his favourite program is about to begin. The system allows the user to set an e-mail message to be sent at a specified time to an e-mail address of his choosing. This system is not ideal, as the user has to be near the specified computer at the time the reminder is due.

Furthermore, in this system it is rather cumbersome to enter the reminder message, as the T.V. has to be logged in to the server for the duration of the setting of the reminder. The same applies if the user wishes to later edit the reminder or remove the reminder if the user finds himself in front of the television anyway at the time of the reminder.

The aim of this invention is to provide a more effective and flexible way of using a service station to remind the user of a first device, like a television or personal computer, of a scheduled event.

To this end, the first device in the system comprises means to store the reminder messages and means for automatically transferring the reminder message to the service station.

In this way, there is no need to stay logged into the service station when the reminder is set. The first device can set up the connection at a convenient moment and quickly transfer the reminder to the service station. The user could walk away from the device and leave it to transfer the message.

In a preferred embodiment, the first device comprises means to generate a reminder too. This means that the user can receive the reminder in two ways; directly through the first device, or by way of the second device, using the service station.

Of course, there is little point in sending the reminder from the service station if the user has already received the reminder from the first device. Therefore, it is a further aim of the invention to prevent superfluous reminders from reaching the user. Accordingly, the preferred embodiment of the system suppresses transmission of the reminder to the second device in this case. To this end, the first device comprises means for detecting superfluous reminders in the service station.

The invention will now be explained in further detail, with reference to the drawing, schematically showing a simple diagram of a preferred embodiment of the system according to the present invention.

The modern-day person is confronted with an ever increasing amount of information, provided to him through an ever increasing number of channels. Television, radio and internet provide the consumer with a large offering of content. A lot of it is made available only at selected times. Someone wanting to use all the available channels will need to spend a great deal of effort in keeping an up-to-date schedule. He will also need a way of reminding him when a particular event or broadcast is due.

A manufacturer of a first (multi-media) device 1 could help the user by providing the device 1 with a reminder system, much like an alarm clock. The first device 1 has some means 2 allowing the user to enter the reminder message, and the message is reproduced at the intended time. However, such a system requires the user to be in the vicinity of the first device 1 at the time the reminder is due. Also, the device 1 must be switched on, or at least in a standby mode. In a system according to the present invention, however, this is not necessary, because the user can receive the message on a second device 3, associated with the first device 1. In a system according to the present invention, namely, the message is transferred automatically from the first device 1 to a service station 4, which is always switched on. It is then transferred to the second device 3 which has been selected by the user.

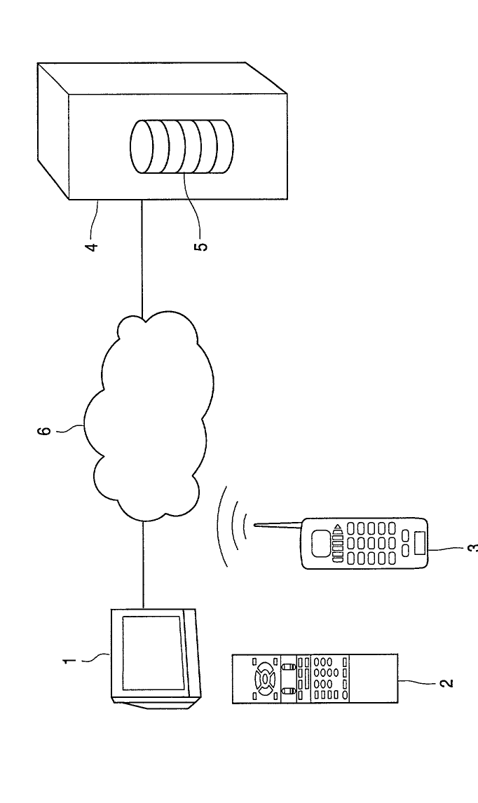

Say a user would like to be reminded of an event associated with a first device 1. In FIG. 1, this first device 1 is a television, but it could just as well be a personal computer or a hi-fi set. The system could even encompass a plurality of first devices 1, comprising all of the above; the principle remains unchanged. There is a second device 3 associated with each first device 1. In the case of multiple users, there would be a different second device 3 for each first device 1. Otherwise, the same device could be associated with more than one first device 1.

Assume the user would like to be reminded of the start of a television program. The first device 1 comprises means 2 for entering a reminder message. In the example of FIG. 1, these means make use of the remote control 2 supplied with the first device 1. In a preferred embodiment, the first device comprises a screen, to be able to provide a graphical user interface displaying the contents of the reminder entered. For maximum ease of use, the first device 1 could be equipped with an electronic program guide, so the user merely needs to select the program from a list. Otherwise, he could enter the channel and the time for the reminder. Further details could also be entered, depending on the exact embodiment of the system and first device 1.

All the first devices 1 that can be used in a system according to the present invention have a means for internally storing the reminder message entered by the user. The first device 1 can transfer the message to the service station 4 at any time after it has been entered.

In a system according to the present invention, this transferral occurs automatically, without any active involvement of the user. The means for storing the message and automatically transferring them represent an improvement over the systems, known hitherto. All types of problems associated with transferral of the message can be solved through the protocols which the means for automatically transferring the reminder message to the service station 4 comprises. This takes away much of the burden experienced by the users of systems known up to now.

It is a relatively simple matter to additionally provide the first device 1 with means for automatically updating the reminder message stored on the service station 4. This comes in useful, when the user of the system later changes the details of a message that has already been entered into the first device 1 and transferred to the service station 4. The means for automatically updating the reminder message on the service station 4, could be implemented by having the first device regularly compare the messages stored in the first device 1 with those stored in the service station 4. In this way, the first device has means for automatically maintaining a current copy of an internally stored reminder in the service station 4.

The second device 3 receives its reminder message from the service station 4 at a later, specified, time.

In one preferred embodiment, the second device 3 comprises a telephone. Generally, people make sure that they are made aware of incoming calls, wherever they are in the house. The telephone number to dial can be part of the details entered with the reminder message.

In the embodiment of FIG. 1, the second device 3 is a mobile phone. When the user is away from home, a mobile phone number could be entered with the details of the reminder message. In this way, the user of the first device 1 always receives the reminder. The same advantages are offered by pagers, which could also be used as the second device 3 in a system according to the present invention.

The kind of reminder message sent to the second device 3 can vary, according to the type of device 3 and service station 4. In the embodiments where the second device 3 comprises a telephone, the service station 4 can comprise means of generating voice messages. Upon answering the telephone, the user hears the reminder message. Alternatively, if the second device 3 comprises a display, the reminder can appear as a text message or graphic. Offering the user a combination of or choice between audio messages and displayed reminders could also be envisaged, especially if the second device 3 is a mobile phone.

The service station 4 storing messages for the second device 3 always has means 5 for storing the reminder message. In the example of FIG. 1, the service station 4 is a specially programmed server. In this case, it could store messages for a group of users or first devices 1. Each device would have an allocation of storage space on one of the disk drives, which in this case form the means 5 for storing reminder messages. Such use makes sense if the service station 4 is maintained by a central service provider. There is no reason why the system should not be smaller, with one service station 4 per household. In this case, it could be a personal computer, or a customised appliance.

Especially when the user has remembered an event associated with the first device 1 by himself, he is more likely to be near the first device 1 at the time the message is due. In a preferred embodiment, the first device 1 therefore also comprises means to alert the user, by generating a reminder message at a specified time, in accordance with the internally stored reminder message details. In the preferred embodiment in which the first device 1 comprises a screen, these details can be displayed on the screen. Because the first device 1 keeps the reminder message in the service station 4 up to date automatically, there is only one version of each reminder message in the system at any one time. Thus, although there are two ways of reminding a user, the contents of the two reminders sent thereby are identical.

Transfer of the reminder messages is through a telecommunications network 6. The internet, a proprietary cable network, a mobile operator's network or the public telephone network could all be partly or wholly comprised in this network, depending on the particular embodiment of the system. For example, the service station 4 could comprise means for directly dialling the telephone number of the second device 3. The first device 1 could comprise a modem for connection to the internet, to which the service station 4 is likewise attached. Alternatively, communication from the first device 1 could involve a cable television network.

The means to determine whether a message to the second device 3 is necessary, can be simple. For instance, if the first device 1 is a radio, the condition can be that it is already tuned in to the correct station. In a more sophisticated, preferred, embodiment, the first device 1 comprises means allowing the user to acknowledge receipt of the first reminder. Thus, for example, he might use the remote control of his T.V. 2 again, to signal that he has read the message that the T.V. has just generated on his screen. If the first device 1 is a P.C. running a program for personal information management, then a click of the mouse could be used. In all these cases, reminder messages, stored on the service station 4, which have become superfluous are detected by the first device 1.

Using its capability to automatically contact the service station 4, the first device 1 can then suppress transmission of a superfluous reminder to the second device 3. This requires no further actions on the part of the user.

The possible ways of realising the invention are not limited exclusively to the examples provided in the figure and the above description. They can be varied in a number of ways according to the scope of the claims.

1. System for reminding a person of an event, comprising at least one first device (1), e.g. a television or computer, with means for entering a reminder message (2), at least one second device (3) associated with each first device (1), a service station (4), with means for storing a reminder message (5) and transmitting it to the second device(s) (3) at a specified time, and a telecommunications network (6) through which a reminder message can be transferred from the first device (1) to the service station (4) and from the service station (4) to the second device(s) (3) associated with the first device (1), characterised in that
the first device (1) comprises means for storing the entered reminder message and means for automatically transferring the reminder message to the service station (4).

2. System according to claim 1, wherein the first device (1) comprises means for automatically maintaining a current copy of an internally stored reminder message in the service station (4).

3. System according to claim 1 or 2, wherein the first device (1) comprises means for generating a reminder at a specified time in accordance with the locally stored details.

4. System according to claims 1-3, wherein the first device (1) comprises means for detecting a superfluous reminder message stored on the service station (4), and means to automatically suppress its transmission to the second device (3).

5. System according to claim 4, wherein the first device (1) comprises means for the user to acknowledge the receipt of a first reminder, wherein said means alert the first device (1) to the existence of a superfluous reminder message in the service station (4).

6. System according to any of the preceding claims, wherein the first device (1) comprises a screen with means for displaying a reminder message thereon.

7. System according to any of claims 1-6, wherein the second device (3) comprises a telephone, and the service station (4) comprises means to place a call to the telephone.

8. System according to any of the preceding claims, wherein the reminder message sent to the second device (3) is a spoken reminder.

9. System according to any of claims 1-8, wherein the second device (3) comprises a screen, and a reminder sent by the service station (4) is displayed on this screen

10. Device (1) comprising means for entering reminder details, suitable for connecting to a service station (4) through a telecommunications network (6) to which at least one second device (3) is attached, further comprising means for transferring a reminder message to the service station (4), wherein the service station (4) comprises means for storing the reminder message and transmitting it at a specified time to each second device (3) associated with the first device (3), characterised in that
the device (1) comprises means for storing the reminder message and automatically transferring it to the service station (4).

11. A computer program, which can be loaded onto a programmable device to provide it with the functionality of the first device (1) of a system according to any of claims 1-9.

12. A computer program, which can be loaded onto a programmable device to provide it with the functionality of the second device (3) comprised by a system according to any of claims 1-9.

13. A computer program, which can be loaded onto a programmable device to provide it with the functionality of the service station (4) comprised by a system according to any of claims 1-9.
